(19) United States
(12) Patent Application Publication
(10) Pub. No.: US 2013/0175388 A1
(43) Pub. Date: Jul. 11, 2013

(54) METHOD AND DEVICE FOR DRIVING AT LEAST ONE LANDING GEAR WHEEL OF AN AIRCRAFT BY MEANS OF A WHEEL MOTOR

(71) Applicants: Guillaume Bulin, Blagnag (FR); Christophe Cros, L'Union (FR)

(72) Inventors: Guillaume Bulin, Blagnag (FR); Christophe Cros, L'Union (FR)

(73) Assignee: AIRBUS OPERATIONS SAS, TOULOUSE (FR)

(21) Appl. No.: 13/635,278

(22) PCT Filed: Mar. 16, 2011
(86) PCT No.: PCT/FR11/50531

§ 371 Date: Mar. 27, 2013

(30) Foreign Application Priority Data
Mar. 17, 2010 (FR) 1051895

(51) Int. Cl. B64C 25/40

(52) U.S. Cl. CPC B64C 25/405
USPC 244/50

(57) ABSTRACT

The invention relates to a device for driving at least one landing gear wheel of an aircraft by means of a wheel motor, which is intended to be used in the stage when the aircraft is traveling on the ground, said aircraft having turbojet engines (1) attached to the main wing. The device comprises at least one power source (6, 8), and one power transmission line between the power source and the wheel motor. The power source (6, 8) is arranged adjacently to a turbojet engine (1) attached to the main wing of the aircraft, and comprises disengageable means (7) enabling the power source to be mechanically connected to the rotating portion of the turbojet engine (1), the power source being sufficient to act as a starter for the turbojet engine (1).

The invention relates to the field of aircraft powering devices. It relates more particularly to the means for moving an aircraft in its movements on the ground (taxiing), particularly when taxiing between a runway and a parking point in the vicinity of an air terminal.

### CONTEXT OF THE INVENTION AND PROBLEM POSED

In their movements on the ground, usually, either the aircraft use their main engines, or they are pulled by appropriate vehicles which transmit a thrust to them at the wheel level. Such is particularly the case with commercial aircraft, for example aircraft with jet engines.

It will be understood that the use of the main engines results, for the operators of these aircraft, in a significant fuel consumption and associated pollution.

The use of a specialized tractor device naturally considerably limits the independence of movement of the aircraft on the ground.

It is already known practice, notably from the patent applications FR 2 930 759 and FR 2 930 760, to have motors on some of the wheel trains, so as to allow the aircraft taxiing autonomy. In these two documents, a microturbine is installed on a wheel train, and a device driving the wheels via these turbines is provided.

However, these devices have the drawback of a certain mechanical complexity, as well as the need to channel fuel or pressurized air to the microturbine, which adds pipelines, and is therefore likely to result in an additional manufacturing cost or weight of the aircraft.

Another arrangement is proposed by the patent application US 2006/0065779 A1 which describes a device comprising an electric motor arranged on the front wheel train of an aircraft. In this document, the electric motor is housed in the rim of a wheel and the necessary electrical power is generated by the auxiliary power generator (APU) of the aircraft.

Because of the power needed to move the aircraft on the ground (some tens of kilowatts, or approximately a third to a half of the power normally supplied by the APU for the other systems using power on the ground), the APU must then be significantly overengineered, which results in an increase in its weight. The saving in fuel consumption may then possibly be counteracted by the additional weight.

Moreover, conveying the electrical power of some tens of kilowatts to the front wheel train of the aircraft entails installing a dedicated power line which also contributes to the complicating of the design of the aircraft, and making it heavier.

### OBJECTIVES OF THE INVENTION

The object of the present invention is therefore to remedy at least one of the problems stated above.

### EXPLANATION OF THE INVENTION

To this end, the invention targets a device for driving at least one landing gear wheel of an aircraft by means of a wheel motor, said device being intended to be used in the taxiing phase of an aircraft, said aircraft being of the type comprising jet engines attached to the main wing unit,

the device comprising at least one power source, and a power transmission line between the power source and the wheel motor,

characterized in that the power source is arranged in the vicinity of a jet engine attached to the main wing unit of the aircraft, and comprises disengageable means to be mechanically linked to the rotating part of the jet engine, the power source being sufficient to serve as starter for the jet engine.

It will be understood that the invention targets a powering device for autonomous taxiing, in which the power generation is no longer located on the wheel train, as in the devices that use a microturbine, but on a main engine.

Moreover, in this way, the microturbine can be used to mechanically start the jet engine, which makes advantageous its installation in proximity to said jet engine.

Preferentially, the device is intended to be used to drive a wheel train arranged under the main wing unit and the power source is arranged in the vicinity of the jet engine closest to said wheel train.

It is obvious that such an arrangement makes it possible to substantially reduce the length of the power line that has to be installed between the electrical generator and the electric motor installed in the wheel train.

According to a particular implementation, the power source comprises a microturbine driving a generator.

This arrangement makes it possible, if necessary, to replace an auxiliary power generator (APU), or to create a redundancy for the latter.

In this case, the microturbine advantageously comprises means for disengageably driving the jet engine that it is close to.

According to a preferred embodiment, the microturbine drives the generator via a free wheel and a speed reducing gear.

In a particular embodiment, for an aircraft that is of the type for which each jet engine is provided with a gearbox, comprising a mechanical transmission linked to the rotating part of the jet engine,

the assembly formed by the microturbine and the electrical generator is linked to the transmission of the gearbox, disengageably, via a controlled mechanical clutch of claw type.

According to a first embodiment, the generator is an electrical generator, the power transmission line is an electricity transport line, and the wheel motor is an electric motor.

This arrangement makes it possible, if appropriate, to replace an auxiliary power generator (APU), or to create a redundancy for the latter.

Alternatively, the generator is a pneumatic generator, the power transmission line is a pneumatic pressure transmission line, and the wheel motor is a pneumatic motor.

Alternatively, the generator is a hydraulic generator, the power transmission line is a pressurized fluid transmission line and the wheel motor is a hydraulic motor.

According to another aspect, the invention targets an assembly formed from a device as explained above, and an aircraft nacelle containing a jet engine, and such that:
the microturbine is installed the nacelle of the jet engine,
the microturbine is supplied with fuel by virtue of a connection to the supply circuit of the jet engine, downstream of a shut-off valve of this jet engine,
the microturbine is supplied with air via an airline linked to the air-cooling system of the area called body of the nacelle of the jet engine,
the microturbine is provided with a hot gas output area, on the outer surface of the nacelle of the jet engine.

In an advantageous embodiment, the microturbine is installed instead of, and in the place usually reserved for, a pneumatic starter of this jet engine, by its supply pipe and its air valve.

According to yet another aspect, the invention targets an aircraft, comprising an assembly as explained above, installed on a single jet engine.

The invention also targets a method for piloting an aircraft on the ground, in a taxiing phase between a landing runway and a parking point, said aircraft comprising at least one assembly as explained above, comprising the following phases:
switching off of the main jet engines,
starting up of at least one microturbine,
starting up of the wheel motor(s) powered by the microturbine,
regulation of the microturbine as a function of the power demanded by the wheel motors,
stopping and restarting of the microturbine depending on the requirements to stop and restart the aircraft during its taxiing.

The invention similarly targets a method for piloting an aircraft on the ground, in a taxiing phase between a parking point and a take-off runway, said aircraft comprising at least one assembly as explained above, comprising the following phases:
starting up of at least one microturbine,
starting up of the wheel motor(s) powered by the microturbine,
regulation of the microturbine as a function of the power demanded by the wheel motor,
stopping and restarting of the microturbine depending on the requirements to stop and restart the aircraft during its taxiing,
starting up of the jet engine linked to the microturbine by engagement of the disengageable means linking with the rotating part of the jet engine,
stopping of the microturbine.

The invention also targets an aircraft comprising at least one device or one assembly as explained above.

According to a particular aspect, the invention targets an aircraft comprising a device in which the generator is an electrical generator, and in which the generator serves as auxiliary power generator (APU) for the aircraft.

It will be understood that, in this case, the electrical generator is simply linked to the electrical distribution systems of the aircraft, as is usually the case with an auxiliary power generator.

### BRIEF DESCRIPTION OF THE FIGURES

The aims and advantages of the invention will be better understood on reading the description and the drawings of a particular embodiment, given as a nonlimiting example, and for which the drawings represent:

FIG. 1: a schematic view of an airplane on which a device according to the invention is implemented,

FIG. 2: a schematic view of a jet engine, of the arrangement of the gearbox and of a power-generating microturbine.

### DETAILED DESCRIPTION OF AN EMBODIMENT OF THE INVENTION

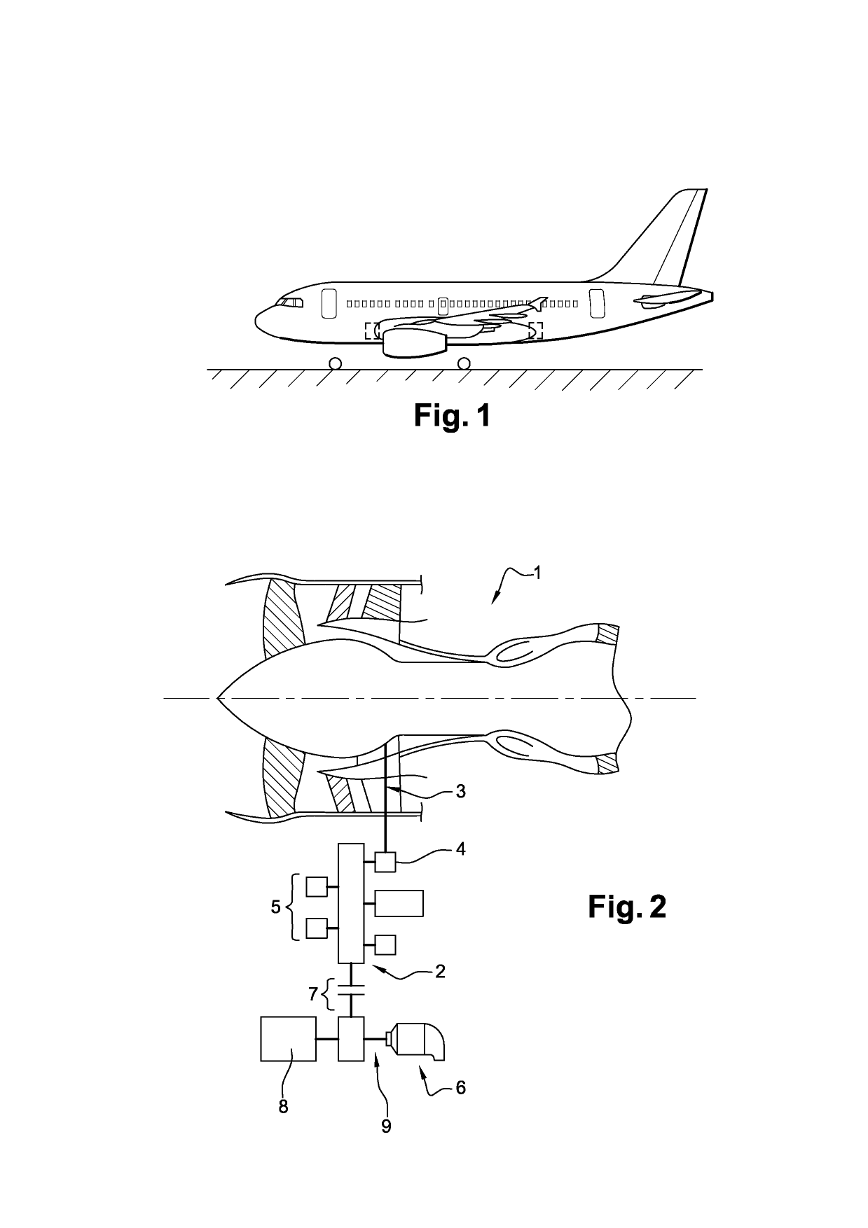

FIG. 1 schematically illustrates the general configuration of an airplane using a device according to the invention. In the present nonlimiting example, the airplane concerned is a passenger transport craft, of the twin-engine type with approximately 150 seats, the jet engines being arranged under the wings of the main wing unit.

As can be seen in FIG. 2, each jet engine is assumed to be provided with a gearbox 2 of conventional type. This gearbox 2 comprises a geared driving device and is linked to the rotating part of the jet engine by a mechanical link of drive shaft 3 and angle transmission 4 type.

The gearbox 2 is used to transmit a portion of the power from the jet engine 1 to various engine accessories 5, for example a hydraulic pump, an electrical generator supplying the current on board the airplane, etc.

In the present exemplary implementation, a microturbine is installed in the nacelle of each jet engine 1, roughly in the place usually used by a air starter of this jet engine 1, by its supply pipe and its air valve.

This microturbine 6 has, in the present nonlimiting example, approximate dimensions of 65 cm in length and 30 cm in diameter, for a weight of 45 kg and a supplied power of 70 kilowatts on the axis of the generator, in the case of a short-medium range carrier twin-engine commercial airplane with approximately 150 seats. It will be understood that the power of the microturbine 6 naturally depends on the power needed to move the airplane on the ground.

The microturbine 6 comprises a free wheel and a speed reducing gear 9, thus allowing for the disengageable driving of an electrical generator 8. This electrical generator 8, of a type known to those skilled in the art, produces, for example, current of the 115 V 400 Hz type. In this way, the pair formed by the microturbine and the electrical generator 8 is capable of replacing an APU of the airplane or a main current generator if necessary.

The assembly formed by the microturbine 6 and the electrical generator 8 is linked to the transmission chain of the gearbox 2, disengageably, via a controlled mechanical clutch 7, for example of claw type, which is known per se.

In this way, and because of its engineering in terms of generated power, the microturbine 6 is capable of being used as a means for igniting the jet engine 1 in order to start up the latter.

However, by controlling the disengaging of the mechanical clutch 7, it is not driven by the transmission chain of the gearbox 2, in normal operation of the jet engine 1, for example during actual flight. Similarly, it is possible to drive the electrical generator 8 by the jet engine 1 through the gearbox 2, by keeping the mechanical clutch 7 engaged, in the absence of operation of the microturbine 6, isolated by the free wheel.

In an embodiment described here as an example, the microturbine 6 is supplied with fuel by virtue of a connection to the supply circuit of the jet engine 1, downstream of the fuel shut-off valve. Similarly, the microturbine 6 is supplied with air via an airline (not represented in the figures), linked to the air-cooling system conventionally present on the area called body of the nacelle of the jet engine 1. It is obvious that this offtake of air remains insignificant in relation to the dimensioning of the air-cooling system of the nacelle of the jet engine 1.

The microturbine 6 is provided with a hot gas output area (also not represented in the figures), on the outer surface of the nacelle of the jet engine 1. This output area is, for example, produced in the form of a metallic area suitable for withstanding the output temperatures of the combustion gases from the microturbine 6. Such a hot gas output area is known to those skilled in the art, and exists, for example, for the hot air outputs of the devices intended to prevent the formation of ice on the leading edges of the wings or nacelles.

In the embodiment described, the microturbine 6 is provided with a silencer, so as to reduce the noise generated, when it is operating on the ground.

One or more electrical cables of known type link the electrical generator 8 to a control system (called power electronics) which is in turn linked to the electric motors, installed in the rim of the wheels of at least one wheel train of the main landing gear. Each electric motor is preferentially of permanent magnet direct current type, but this is not limiting.

In the case where the aircraft uses a variable frequency electrical network, it is possible to envisage directly controlling a motor of inductive type by the output frequency of the electrical generator 8 (of “variable frequency” type) therefore by controlling the speed of rotation of the microturbine 6. This solution makes it possible to directly link the electrical generator 8 to the motors and to dispense with an additional control system (saving on volume and weight). However, this solution is more complex to implement from the technical point of view.

In the case of presence of power electronics, the control modules may either be pooled in the electrical system of the airplane (case of a so-called “more electrical” airplane), or else specific to the taxiing system. In the first case, the electrical generator 8 has only one electricity distribution system, and the switching to supply the taxiing system is done in the electrical core of the airplane. In the second case, a specific electrical network is derived from the electrical generator 8 in parallel with the electrical network of the airplane (used to power the airplane when the engines are ignited). The switching between the two networks is handled at the level of the generator.

When the power electronics is specific, it has to be situated as close as possible to the engines to limit the length of the power supply cables. The technologies commonly used on an airplane require these components to be positioned in a pressurized area. The ideal situation is then in proximity to the appropriate wheel train cell:
Back of the forward cargo compartment
Front of the aft cargo compartment
Between the wheel train cell and the cabin floor.

The future technologies will probably make it possible to locate such equipment in an unpressurized area. Encouraging prospects can then be envisaged such as, for example:
Directly in the nacelle, in proximity to the generator
In the mast (for example like the extinguishers in a current A320 mast)
In the mast fairing
In the wheel train cell
In ventral wing unit fairing.

Such an electric motor is known per se, and, for example, described in the patent application US 2006/0065779 A1 or in the document WO 2007/048164 A1. Its precise arrangement and its type are beyond the scope of the present invention, and are not therefore detailed more here.

The regulation of the microturbine 6 is done according to the power demanded by the electric motors of the wheels. Such a regulation of the power on the shaft of a turbine is well known to those skilled in the art and is not therefore detailed more here.

### MODE OF OPERATION

In its normal mode of operation, the microturbine 6 is used in the airplane taxiing phases, either in taxi-in phase (taxiing from the landing runway to the arrival gate), or in taxi-out phase (from the departure gate to the take-off runway).

In these phases, and on command from the pilot, the jet engines 1 are stopped, and the microturbines 6 started up. The associated electrical generators 8 produce current which is routed to the electric motors arranged in the rims of certain wheels of the main landing gear. It is then possible to control the power produced by the electrical generators, and to perform, in particular, stops and restarts of the microturbines 6 depending on the requirements.

A centralized system has two advantages compared to a localized system:
Independence of the driven wheels with respect to the origin (right or left) of the power. It is therefore possible to envisage powering all the motors with a single turbine in operation (when the power requirement is moderate, such as when reverse thrusting for example). The fuel consumption benefits are therefore increased.
Pooling with the energy system of the airplane. This solution makes it possible to pool certain heavy components, and consider the use of the system to power other systems. This solution is of particular interest when the microturbines are used as a replacement for the APU.

### ADVANTAGES

The device as described provides the airplane with taxiing autonomy, which makes it possible, for example, to avoid having said airplane wait for the availability of a tractor vehicle. Given the congestion of certain airports, the time saving is likely to prevent the loss of a take-off slot, hence an advantage in terms of operational use of the airplane.

It is obvious that the arrangement of the microturbine in the immediate vicinity of the wheel train, on which is installed a driving electric motor, constitutes a significant advantage inasmuch as this arrangement avoids the installation of high-power electrical lines between the APU and the wheels, which is the case of the devices which would use a supply of electrical current to the wheel motors by the APU.

It should be noted that the microturbine 6 benefits, by virtue of its installation within the nacelle of the jet engine, from the systems protecting against fire (engine extinguishing device) or leaks of fuel or oil, already installed to protect the jet engine 1. Because of this, the device offers good operating safety.

It will also be noted that, because of the very short delay in starting up the microturbines, it is possible to stop or restart the latter at will, when the airplane is taxiing, which makes it possible to significantly reduce fuel consumption.

### VARIANTS

The scope of the present invention is not limited to the details of the above embodiments considered by way of example, but, on the contrary, extends to the modifications within the scope of those skilled in the art.

It is, for example, possible to consider, as a variant, the installation of a microturbine offering 140 kW of supplied power on a single jet engine of the airplane, instead of two 70 kW microturbines each installed on one jet engine of the airplane, as described above.

In the description, the installation of an electrical generator driven by the microturbine has been considered. It is also possible to have instead a hydraulic generator of known type, again responsible for recovering a portion of the mechanical power supplied by the microturbine 2, and a hydraulic pressure line to a wheel train of the airplane.

The use of the microturbines can then be envisaged when moving an airplane on the ground for maintenance, in the case where the jet engines are off, where the APU cannot be used and where the hydraulic systems are therefore inoperative. In this case, the device as described can be used for the taxiing, the steering and the braking, by powering the basic hydraulic systems with the exclusion in particular of the flight controls.

1. A device for driving at least one landing gear wheel of an aircraft by means of a wheel motor, said device being intended to be used in the taxiing phase of an aircraft, said aircraft being of the type comprising jet engines (1) attached to the main wing unit,
the device comprising at least one power source, and a power transmission line between the power source and the wheel motor,
characterized in that the power source (6, 8) is arranged in the vicinity of a jet engine (1) attached to the main wing unit of the aircraft, and comprises disengageable means (7) to be mechanically linked to the rotating part of the jet engine (1), the power source being sufficient to serve as starter for the jet engine (1).

2. The device as claimed in claim 1, intended to be used to drive a wheel train arranged under the main wing unit, characterized in that the power source (6, 8) is arranged in the vicinity of the jet engine (1) closest to said wheel train.

3. The device as claimed in claim 1, characterized in that the power source comprises a microturbine (6) driving a generator (8).

4. The device as claimed in claim 3, characterized in that the microturbine (6) drives the generator (8) via a free wheel and a speed reducing gear (9).

5. The device as claimed in claim 3, for an aircraft that is of the type for which each jet engine (1) is provided with a gearbox (2), comprising a mechanical transmission linked to the rotating part of the jet engine (1),
characterized in that the assembly formed by the microturbine (6) and the electrical generator (8) is linked to the transmission of the gearbox (2), disengageably, via a controlled mechanical clutch (7) of claw type.

6. The device as claimed in claim 1, characterized in that the generator (8) is an electrical generator, the power transmission line is an electricity transport line, and the wheel motor is an electric motor.

7. The device as claimed in claim 1, characterized in that the generator (8) is a pneumatic generator, the power transmission line is a pneumatic pressure transmission line, and the wheel motor is a pneumatic motor.

8. The device as claimed in claim 1, characterized in that the generator (8) is a hydraulic generator, the power transmission line is a pressurized fluid transmission line, and the wheel motor is a hydraulic motor.

9. An assembly formed from a device as claimed in claim 3, and an aircraft nacelle containing a jet engine (1),
characterized in that:
the microturbine (6) is installed in the nacelle of the jet engine (1),
the microturbine (6) is supplied with fuel by virtue of a connection to the supply circuit of the jet engine (1), downstream of a shut-off valve of this jet engine (1),
the micro turbine (6) is supplied with air via an airline linked to the air-cooling system of the area called body of the nacelle of the jet engine (1),
the microturbine (6) is provided with a hot gas output area, on the outer surface of the nacelle of the jet engine (1).

10. The assembly as claimed in claim 6, characterized in that the microturbine (6) is installed instead of, and in the place usually reserved for, a pneumatic starter of this jet engine (1), by its supply pipe and its air valve.

11. A method for piloting an aircraft on the ground, in a taxiing phase between a landing runway and a parking point, said aircraft comprising at least one assembly as claimed in claim 9, characterized in that it comprises the following phases:
switching off of the main jet engines (1),
starting up of at least one microturbine (6),
starting up of the wheel motor(s) powered by the microturbine (6),
regulation of the microturbine (6) as a function of the power demanded by the wheel motor(s),
stopping and restarting of the microturbine (6) depending on the requirements to stop and restart the aircraft while it is taxiing.

12. An aircraft, characterized in that it comprises a device as claimed in claim 1.

13. An aircraft, characterized in that it comprises at least one device as claimed in claim 6, and in which the generator (8) serves as auxiliary power generator (APU) for the aircraft.

14. An aircraft, characterized in that it comprises at least one assembly as claimed in claim 8.
